(19) United States
(12) Patent Application Publication
(10) Pub. No.: US 2019/0378171 A1
(43) Pub. Date: Dec. 12, 2019

(54) TARGETED ADVERTISEMENT SYSTEM

(71) Applicant: Walmart Apollo, LLC, Bentonville, AR (US)

(72) Inventors: Rajesh Shreedhar Bhat, Kumta (IN); Souraj Mishra, Allahabad (IN); Kushal M. Kumar, Bangalore (IN); Abhishek Ramesh, Mysore (IN); Nanda Kishore Reddy, Nellore (IN)

(21) Appl. No.: 16/433,771

(22) Filed: Jun. 6, 2019

Related U.S. Application Data
(60) Provisional application No. 62/733,796, filed on Sep. 20, 2018.

(30) Foreign Application Priority Data
Jun. 6, 2018 (IN) 201811021105

(51) Int. Cl. G06Q 30/02; G06N 3/08; G06K 9/00; G06K 9/62

(52) U.S. Cl. CPC G06Q 30/0269; G06N 3/08; G06K 2009/00322; G06K 9/6269; G06K 9/00228

(57) ABSTRACT

Systems, methods, and machine readable media are provided for targeted advertising. One or more images of individuals in a location in a facility are captured with an imaging device. Face detection is performed on the one or more images. Based on a face detection result, Convolutional Neural Network models are used to determine a gender and estimate an age of each detected face. A targeted audience is determined, based on pre-determined criteria using the age estimation and gender identification of each detected face. A relevant advertisement is selected for the targeted audience for display on a display device. The relevant advertisement may be selected based at least in part on a footfall score (f_{score}) indicative of customer traffic in the facility.

### CROSS-REFERENCE TO RELATED APPLICATIONS

This application claims priority to and the benefit of Indian Patent Application No. 201811021105, filed Jun. 6, 2018, and U.S. Provisional Patent Application No. 62/733,796, filed Sep. 20, 2018, the disclosures of which are incorporated herein by reference in their entirety.

### BACKGROUND

Conventional product marketing typically involves sending flyers, airing television commercials and having an online presence. For companies with a brick-and-mortar store, the marketing may continue even when the consumers are already in the store. Often, customers are not sure what they want to buy or may just be browsing without intent to buy. Marketing inside a store may involve putting up a few banners and signs or may involve everything from the way the products are stacked on the shelves to the use of lighting to make certain merchandise stand out.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not necessarily to scale, or inclusive of all elements of a system, emphasis instead generally being placed upon illustrating the concepts, structures, and techniques sought to be protected herein. In the drawings:

FIG. 1A is a process flow diagram for a targeted advertising system, according to an example embodiment.

FIG. 1B is a process flow diagram for gender identification in a targeted advertising system, according to an example embodiment.

FIG. 1C is a process flow diagram for age estimation in a targeted advertising system, according to an example embodiment.

FIG. 2 is a flowchart illustrating an exemplary method for targeted advertising according to an example embodiment.

FIG. 3 is a flowchart illustrating an exemplary method for determining a product category score used in a targeted advertising system, according to an example embodiment.

FIG. 4 is a diagram of an exemplary network environment suitable for a targeted advertisement system of exemplary embodiments.

FIG. 5 is a block diagram of an exemplary computing device that may be used to implement exemplary embodiments described herein.

### DETAILED DESCRIPTION

Embodiments of the present invention provide a mechanism for targeted advertising directed to individuals within a facility. In one embodiment, image acquisition devices are used to acquire images of individuals at locations proximate to display devices in the facility. Facial detection and Convolutional Neural Networks (CNN) are used to perform age estimation and gender identification. The age estimation and gender identification of the detected individuals is used in combination with footfall traffic indicative of customer traffic in various locations of the facility to select a relevant advertisement for display to the identified individuals on a nearby display device.

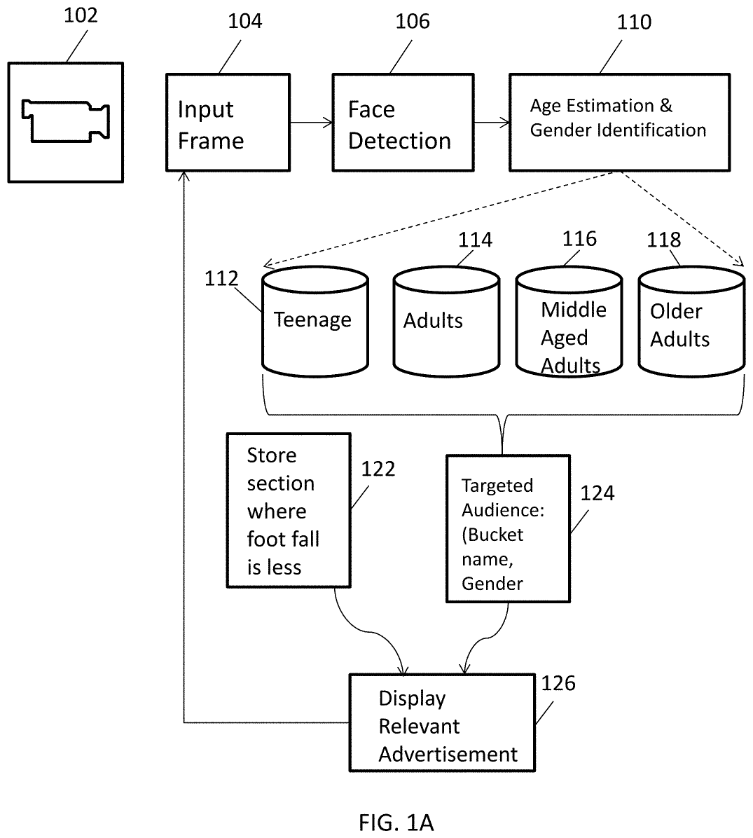

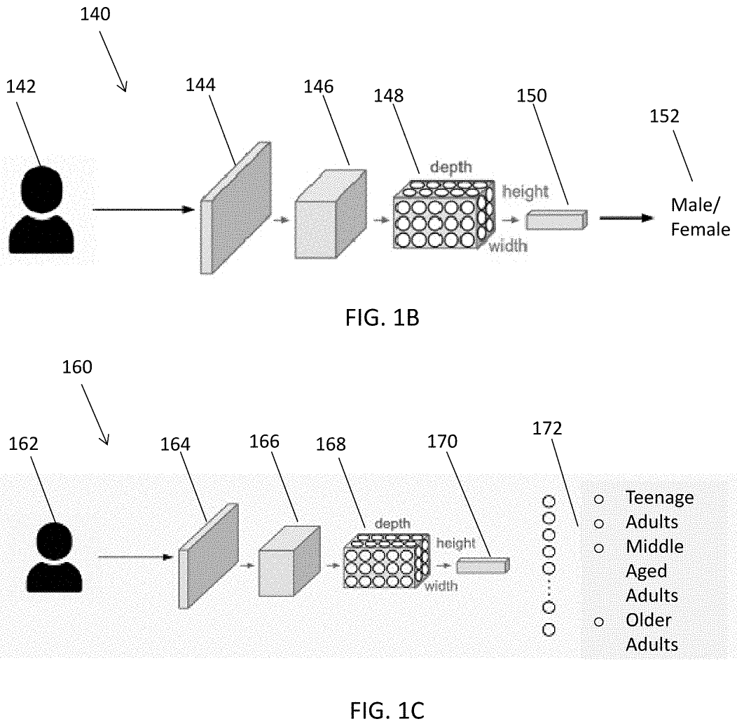

FIG. 1A shows a targeted advertisement system 100 in accordance with a particular embodiment. The targeted advertisement system 100 includes an imaging device 102, such as, but not limited to a camera, for taking pictures and/or video of customers proximate to a certain location in a retail environment. The image provides an input frame (step 104) and a face detection module is executed that analyzes the input frame to detect the presence of one or more faces in the frame.

For example, in one embodiment, a linear Support Vector Machine (SVM) is trained and used to differentiate facial and non-facial images. A support vector machine is a supervised learning model and associated learning algorithms that analyze data for regression and classification analysis. Given a set of training examples with each example being marked as belonging to one of two categories, an SVM training algorithm builds a model that assigns new examples to one category or the other. In one exemplary embodiment, a face detection algorithm employs a sliding window approach which creates various size windows across the image. For each window 512 length vectors (a list containing 512 elements, wherein the lengths are tunable) based on a histogram of oriented gradients are determined. These vectors are fed to a trained linear SVM, which determines whether the image is a face or not. The face detection module may further incorporate non-maximal suppression to remove overlapping windows across a single face.

Once the facial detection module has performed facial detection, the targeting advertising system utilizes CNN to perform age estimation and gender identification for the detected faces. The use of a CNN by embodiments is discussed in more detail below.

In one embodiment, customer segmentation (male and female) is performed based on age by grouping customers into different age categories. For example, a customer's age may be categorized as one of four potential groups: A1—Teenage—M/F (112), A2—Adults—M/F (114), A3—Middle-aged adults—M/F (116), and A4—Older aged adults—M/F (118). It will be appreciated that the above groupings are illustrative and other age groupings may also be utilized by embodiments of the present invention.

In one embodiment, customers may be grouped based on age, gender or both when selecting a relevant advertisement. Pre-determined criteria may indicate which factors are considered. For example, in one embodiment, the grouping criteria may be based upon whether or not one gender constitutes a 70% majority of the total customers at the location. For example, if there are five males and five females at a particular location, the criteria may indicate that the gender of the customers should be ignored as it makes more sense to show an advertisement which is pre-categorized as relevant to both genders or to ignore gender in selecting the advertisements. In contrast, when a large majority of individuals are one gender versus another an advertisement directed to individuals of the majority gender may be selected as appropriate by the targeted advertising system.

Similarly, a determination may also be made regarding which age grouping applies to a majority of the people in the location. Based on the number of the people present in the location an age group is determined as set forth above. The pre-determined criteria may then combine this information with the gender information or consider it in isolation. For example, if there are ten people near a location of a product category in a store and seven of them are males and three of them are females, the majority is male (M). If there are a majority of middle aged adults (A3) then a targeted audience grouping is of middle aged males may be selected (A3, M) 116. Based on targeted audience, pre-categorized advertisements associated with that target audience and the products at the location may be displayed on the nearby display screens (step 126).

In one embodiment, a “footfall” measurement may also be used along with the target audience to select a relevant advertisement (step 124). The term “footfall” measurement relates to customer traffic in the facility. In one embodiment, the footfall is based on the number of purchases of products at various locations in the facility. By tracking which products were purchased in the facility, the traffic in the different locations can be estimated as the locations of the products are known. The number of customers identified can be used to estimate the number of customers in the facility. Using a mapping of a product category at a location to the number of customers purchasing that product, a heat map of the store showing footfalls in different store locations can be determined. A score inversely proportional to the footfall for a given location is determined. This score is referred to as the f_score. The f_score can be used to trigger advertisements for products currently seeing lesser or greater amounts of customer traffic at their locations.

For example, in one embodiment, from the footfall determination, a map of each product category to the score which is inversely proportion to the footfall for that product location in the store is produced that shows where the footfall is less (step 122). In combination with the targeted audience determination, one or more advertisements relevant to the target audience may be identified and displayed (step 126). It will be appreciated that in another embodiment, the map of each product category to the score may instead be made proportional to the footfall for that product location in the facility.

In an embodiment, product scores equal to the score of the category from footfall information is assigned. Then this score is normalized linearly to be within [0,1] interval. This score is referred to as a p_{score}.

$$\frac{{f}_{score} - min ( {f}_{score} )}{max ( {f}_{score} ) - min ( {f}_{score} )}$$

In addition, for each such segment there may be a number of advertisements. A score is assigned, normalized over all categories to an interval [0, 1], which is proportional to the number of advertisements relevant to the category. This score is referred to as the a_{score}. This score relates to relevant advertisements considering the age and gender information obtained earlier. Thus, for the present crowd detected, a shortlist of all possible advertisements, those which are relevant to the age and gender groupings, is determined.

From the above, a score for each category is determined, which is proportional to the number of advertisement relevant to a category. As noted above, another score that is inversely proportional to the average footfall a category receives may also be calculated. A weighted average of these two scores produces a final score for the category. Therefore, the score of category i is given by

Scoreᵢ=αp_{score}+(1−α)a_{score}

An advertisement is displayed 126 based on the probability distribution given by the score. If {C₁, C₂, . . . , Cₙ} is the set of all categories the probability that i^{th} category will be proportional to score Cᵢ.

It should be appreciated that other calculations for determining relevant advertisements in addition to, or instead of, those discussed herein are also possible within the scope of the present invention. For example, footfall traffic calculations may be used to select relevant advertisements for identified customers to alternately increase traffic to products that have sold well or have not sold well but that still may be of interest to the grouping of identified individuals.

FIG. 1B is an example process flow 140 for using CNN to identify the gender of detected faces in the captured image. The model is first trained using a minimal set of images such that the model learns how to classify certain feature(s) of an image and to determine a gender associated with the features(s). Convolutional layers 144 apply a convolution operation to the input image 142, passing the result to the next layer 146. The convolution emulates the response of an individual neuron to visual stimuli. The max pooling 146 uses the maximum value from each of a cluster of neurons at the prior layer to provide a flattened features element 148. The output of the flattened features element 148 is used to form a fully connected neural net 150, from which an output (male or female gender determination) 152 is produced.

FIG. 1C is an example process flow 160 for using CNN to provide age estimation of detected faces in the captured image. The model is first trained using a minimal set of images such that the model learns how to classify certain features of an image and to perform an age estimation. Convolutional layers 164 apply a convolution operation to the image input 162, passing the result to the next layer 166. The convolution emulates the response of an individual neuron to visual stimuli. The max pooling 166 uses the maximum value from each of a cluster of neurons at the prior layer to provide a flattened features element 168. The output of the flattened features element 168 is used to form a fully connected neural net 170, from which an output (teenage, adults, middle age adults or older adults estimation) 172 is produced.

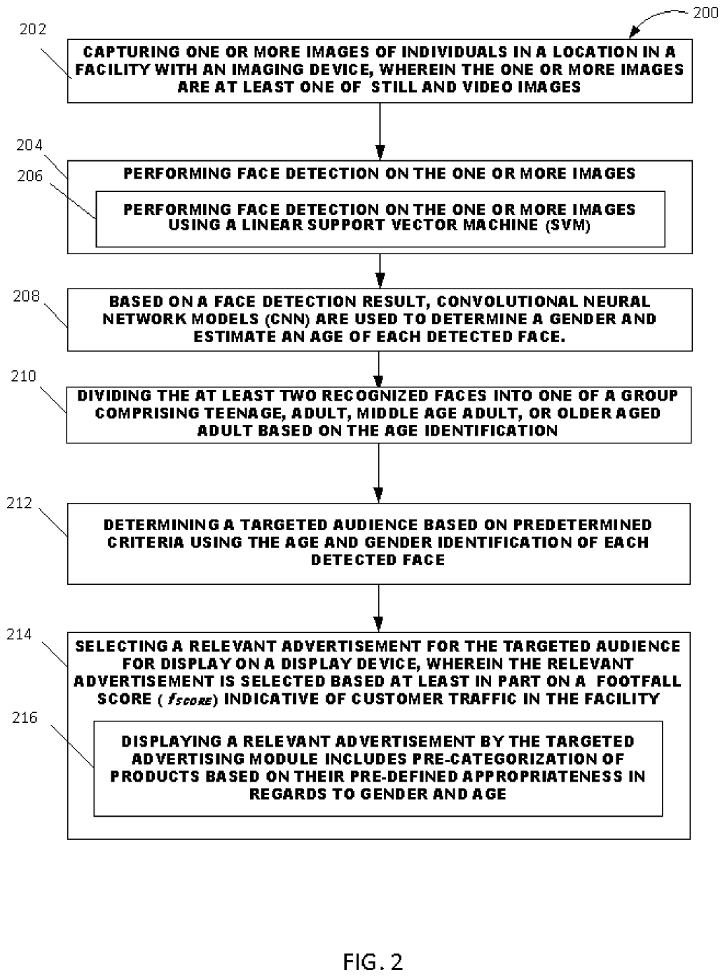

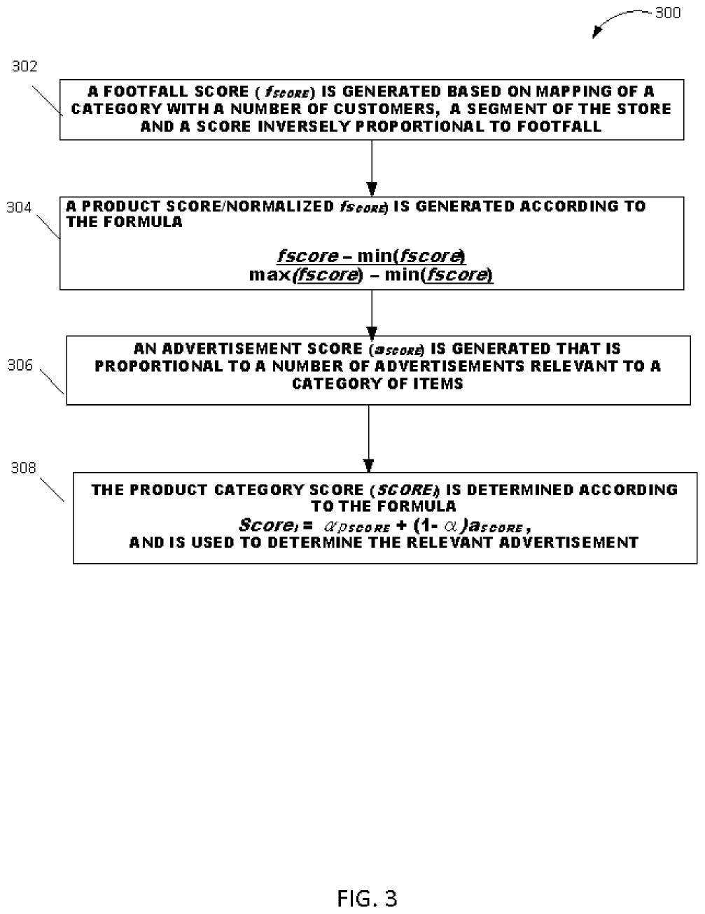

FIG. 2 and FIG. 3 are flow diagrams showing illustrative processing that can be implemented within a system for targeted advertising in an exemplary embodiment. Rectangular elements are herein denoted “processing blocks” and may represent actions performed at least in part by the execution of computer software instructions or groups of instructions. Alternatively, the processing blocks may represent steps performed by functionally equivalent circuits such as a digital signal processor (DSP) circuit or an application specific integrated circuit (ASIC). The flow diagrams do not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

FIG. 2 is a flowchart illustrating an exemplary method 200 for targeted advertising, according to an example embodiment. The method 200 may be performed using one or more modules of system 100 described above.

An image of people in a retail location is captured (step 202). The image may be a still image or series of images from a video capture.

Face detection is performed on the captured image (step 204). This step is performed to determine the presence of customers within an area of the retail store. If no faces are detected, then another image is captured at a later time and the face detection performed on the latest captured image. In certain embodiments, the face detection is performed using a linear Support Vector Machine (SVM) (step 206). In some embodiments, the SVM is trained and used to differentiate facial and non-facial images. In one exemplary embodiment, a face detection algorithm employees a sliding window approach which creates various size windows across the image. For each window, 512 length vectors (lengths are tunable) based on a histogram of oriented gradients are determined. These vectors are fed to the trained linear SVM, which determines whether the image is a face or not.

CNN is used to perform gender identification and age estimation. The captured image is provided to a first CNN model for gender identification and a second CNN model for age estimation (step 208). The gender identification is one of either male or female. The age estimation is one of teenage, adult, middle aged adult, or older adult (step 210).

A targeted audience, based on the age grouping and the gender identification, is determined (step 212). A relevant advertisement is displayed on a display device proximate to the targeted audience (step 214). The relevant advertisement is based on a pre-categorization of products selected for their appropriateness in regards to gender and age is displayed (step 216).

FIG. 3 is a flowchart illustrating an exemplary method 300 for determining a relevant advertisement to be displayed in an exemplary embodiment. The method 300 may be performed using one or more modules of system 100 described above. A footfall score (f_{score}) is generated (step 302). The footfall score is based on a mapping of a product category with a number of customers, a store location, and a score inversely proportional to footfall.

A product score (p_{score}) based on the f_{score} is generated (step 304). This score gives an approximation of the average footfall information in a given category. In one example, this score is a normalized f_{score} The higher this score lesser the footfall, and lesser the footfall higher score. Inverse relation is to give more weight to categories which have less footfall. In certain embodiments the product score is generated according to the formula:

$$\frac{{f}_{score} - min ( {f}_{score} )}{max ( {f}_{score} ) - min ( {f}_{score} )}$$

An advertisement score (a_{score}) is also determined (step 306). The advertisement score is proportional to a number of advertisements relevant to a category of items. This score gives the idea of number of advertisement for a given category. Since different categories have different number of products in them and not all products have an advertisement for them. Therefore, each category has a different number of advertisements. This score reflect these differences. The higher the number of advertisement in a category, the higher this score and more the a_{score} and vice versa.

A product category score is determined based on the product score and the advertisement score (step 308). The product category score is alpha*p_{score}+beta*a_{score}. Alpha and Beta) are the weights indicating which of these two factors has more importance in final advertisement selection. Hence, this score takes into effect both footfall information and advertisements count information in appropriate proportions.

In one example the product category score is determined according to the formula

Scoreᵢ=αp_{score}+(1−α)a_{score}

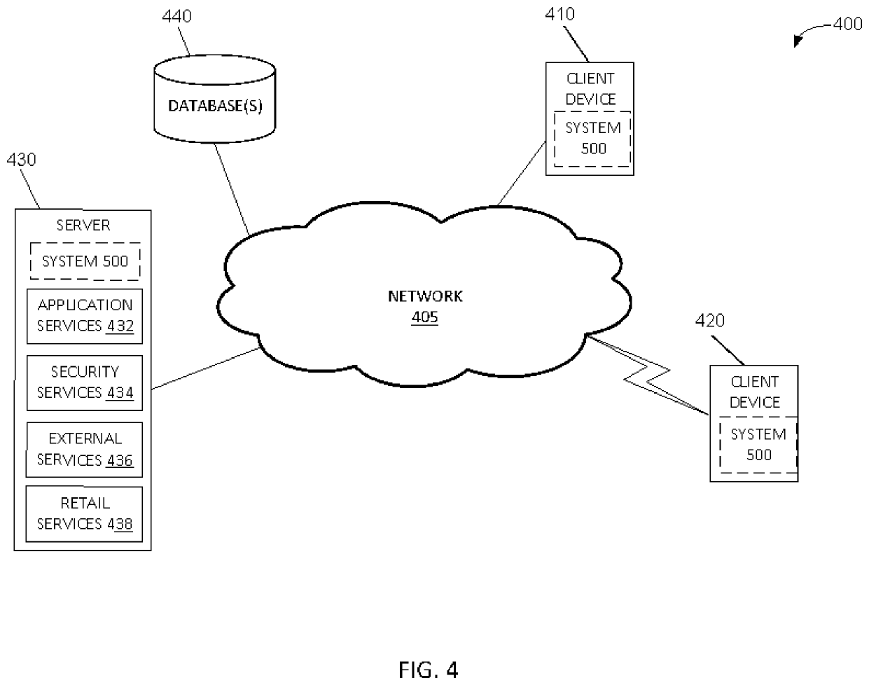

FIG. 4 illustrates a network diagram depicting a system 400 for implementing the targeted advertising system, according to an example embodiment. The system 400 can include a network 405, multiple client devices, for example, client device 410, client device 420, a server 430, and database(s) 440. Each of the client devices 410, 420, server 430, and database(s) 440 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

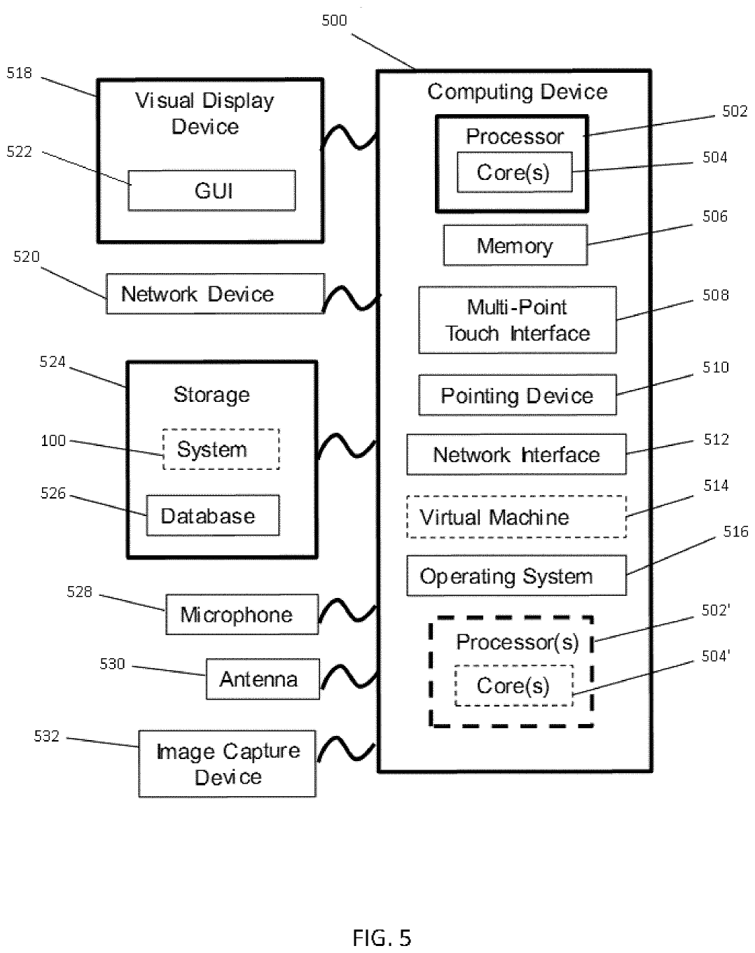

The client devices 410, 420 may comprise, but are not limited to, mobile devices, hand-held devices, wireless devices, portable devices, wearable computers, cellular or mobile phones, portable digital assistants (PDAs), smart phones, smart watches, tablets, ultrabooks, netbooks, laptops, desktops, multi-processor systems, microprocessor-based or programmable consumer electronics, and the like. Each of client devices 410, 420 may connect to network 405 via a wired or wireless connection. In an example embodiment, the client devices 410, 420 may perform one or more of the functionalities of the targeted advertising system described herein, or transmit data or signals to the targeted advertising system described herein. The client device 410, 420 can include one or more components of computing device 500 of FIG. 5.

In an example embodiment, the targeted advertising system 100 may be included at least in part on the client device 410, 420, and the client device 410, 420 performs one or more of the functionalities of the system described herein. In an example embodiment, the targeted advertising system may be included at least in part on the server 430, and the server 430 performs one or more of the functionalities of the targeted advertising system described herein.

The database(s) 440 comprise one or more storage devices for storing data and/or instructions (or code) for use by the server 430 and/or the client devices 410, 420. Each of the database(s) 440 and the server 430 is connected to the network 405 via a wired connection. Alternatively, one or more of the database(s) 440 and server 430 may be connected to the network 405 via a wireless connection. The server 430 comprises one or more computers or processors configured to communicate with the client devices 410, 420 via network 405. The server 430 can include one or more components of device 500 of FIG. 5. Server 430 hosts one or more software systems, applications or websites, including one or more components of the dynamic delivery system 100 described herein and/or facilitates access to the content of database(s) 440.

In an example embodiment, the server 430 also includes various software services that facilitate the functionalities of the targeted advertising system. Database(s) 440 and server 430 may be located at one or more geographically distributed locations from each other or from client devices 410, 420. Alternatively, database(s) 440, 445 may be included within server 430.

FIG. 5 is a block diagram of an exemplary computing device 500 that can be used to perform one or more steps of the methods provided by exemplary embodiments. For example, computing device 500 may be the client device 410, 420 and the server 430 as described in FIG. 4. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flash drives), and the like. For example, memory 506 included in the computing device 500 can store computer-readable and computer-executable instructions or software for implementing exemplary embodiments. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (704 and 504′) processor.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other types of memory as well, or combinations thereof. An individual can interact with the computing device 500 through a visual display device 518, such as a touch screen display or computer monitor, which can display one or more user interfaces 519 for receiving data from the individual (e.g., order data and travel data). The visual display device 518 can also display other aspects, elements and/or information or data associated with exemplary embodiments. The computing device 500 can include other I/O devices for receiving input from a individual, for example, a keyboard or another suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals.

The computing device 500 can also include one or more storage devices 524, such as a hard-drive, CD-ROM, or other computer readable media, for storing data and computer-readable instructions and/or software, such as one or more modules of the system 100 shown in FIG. 1 that implements exemplary embodiments of the notification system as described herein, or portions thereof, which can be executed to generate user interface 519 on display 518. Exemplary storage device 524 can also store one or more databases for storing suitable information required to implement exemplary embodiments. The databases can be updated by an individual or automatically at a suitable time to add, delete, or update one or more items in the databases. Exemplary storage device 524 can store one or more databases 926 for storing provisioned data, and other data/information used to implement exemplary embodiments of the systems and methods described herein.

The computing device 500 can include a network interface 512 configured to interface via one or more network devices 522 with one or more networks, for example, Local Area Network (LAN), Wide Area Network (WAN) or the Internet through a variety of connections including, but not limited to, standard telephone lines, LAN or WAN links (for example, 802.11, Ti, T3, 56 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or another device suitable for interfacing the computing device 500 to a type of network capable of communication and performing the operations described herein. Moreover, the computing device 900 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run an operating system 516, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 516 can be run in native mode or emulated mode. In an exemplary embodiment, the operating system 516 can be run on one or more cloud machine instances.

The description is presented to enable a person skilled in the art to create and use a computer system configuration and related method and systems for dynamic delivery scheduling. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

The systems and methods described herein can be configured to comply with privacy requirements which may vary between jurisdictions. For example, before any recording, collection, capturing or processing of user biometric data, a “consent to capture” process may be implemented. In such a process, consent may be obtained, from the user, via a registration process. Part of the registration process may be to ensure compliance with the appropriate privacy laws for the location where the service would be performed. The registration process may include certain notices and disclosures made to the user prior to the user recording the user's consent. No unauthorized collection or processing of biometric data of individuals occurs via exemplary systems and methods.

After registration, and before collection or processing of biometric data of the user occurs, a verification of the user as registered with the system and providing the required consents can occur. That is, the user's registration status as having consented to the collection of biometric data can be verified prior to collecting any biometric data. This verification can take place, for example, by the user entering a PIN (Personal Identification Number), password, or other code into a keypad or keyboard; by the user entering into a limited geofence location while carrying a fob, mobile device (such as a smartphone), or other RF transmitter, where the device has been configured to broadcast an authorization signal.

Once consent is verified, biometric data of the user can be captured, processed, and used. Absent verification of consent, the camera, sensor, or other biometric data collection system must remain turned off. Once consent is verified, the camera, sensor, or other biometric data collection system may be activated or turned on. If any biometric data is inadvertently collected from the user prior to verification of consent it is immediately deleted, not having been saved to disk.

Preferably, any biometric data captured as part of the verification process is handled and stored by a single party at a single location. Where data must be transmitted to an offsite location for verification, certain disclosures prior to consent may be required, and the biometric data is encrypted. The hashing of the biometric data received is a form of asymmetrical encryption which improves both data security and privacy, as well as reducing the amount of data which needs to be communicated.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component, or step. Likewise, a single element, component, or step can be replaced with a plurality of elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions, and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A system for targeted advertising, the system comprising:
an imaging device configured to take one or more images of a plurality of individuals at a location in a facility, wherein the one or more images are at least one of still and video images;
a display device configured to display an advertisement at the location;
a computing device in communication with the imaging device and the display device and configured to execute a targeted advertising module, wherein the targeted advertisement module, when executed:
receives the one or more images from the imaging device;
performs face detection on the one or more images;
produces, based on the faces detected, age estimation and gender identification for each detected face using a Convolutional Neural Network (CNN) based deep learning model;
determines a targeted audience based on pre-determined criteria using the age and gender identification of each detected face; and
selects a relevant advertisement for the targeted audience for display on the display device, wherein the relevant advertisement is selected based at least in part on a footfall score (f_{score}) indicative of customer traffic in the facility.

2. The system of claim 1, wherein the computing device uses a linear support vector machine (SVM) to perform face detection on the one or more images.

3. The system of claim 1, wherein the targeted advertising module divides the at least two detected faces into one of a group comprising teenage, adult, middle age adult, or older aged adult based on the age identification.

4. The system of claim 1, wherein the targeted advertising module displays a relevant advertisement based on pre-categorization of products based on their pre-defined appropriateness in regards to gender and age.

5. The system of claim 1, wherein the footfall score (f_{score}) is generated based on mapping of a product category with a number of customers, a location within the store, and a score proportional to footfall.

6. The system of claim 1, wherein the product category score is determined according to the formula
Scoreᵢ=αp_{score}+(1−α)a_{score},
and is used to determine the relevant advertisement.

7. The system of claim 6, wherein the product score (p_{score}) is generated according to the formula
$$\frac{{f}_{score} - min ( {f}_{score} )}{max ( {f}_{score} ) - min ( {f}_{score} )}$$

8. The system of claim 6, wherein an advertisement score (a_{score}) is generated that is proportional to a number of advertisements relevant to a category of items.

9. A computer-implemented method for targeted advertising, the method comprising:
capturing one or more images of a plurality of individuals in a location in a facility with an imaging device, wherein the one or more images are at least one of still and video images;
performing face detection on the one or more images;
producing, based on the faces detected, age estimation and gender identification for each detected face using a Convolutional Neural Network (CNN) based deep learning model;
determining a targeted audience based on pre-determined criteria using the age and gender identification of each detected face; and
selecting a relevant advertisement for the targeted audience for display on a display device, wherein the relevant advertisement is selected based at least in part on a footfall score (f_{score}) indicative of customer traffic in the facility.

10. The computer-implemented method of claim 9, wherein performing face detection on the one or more images includes using a linear support vector machine (SVM).

11. The computer-implemented method of claim 9, wherein the determining a targeted audience includes dividing the at least two detected faces into one of a group comprising teenage, adult, middle age adult, or older aged adult based on the age identification.

12. The computer-implemented method of claim 9, wherein displaying a relevant advertisement by the targeted advertising module includes pre-categorization of products based on their pre-defined appropriateness in regards to gender and age.

13. The computer-implemented method of claim 9, further comprising generating the footfall score (f_{score}) based on mapping of a product category with a number of customers, a location within the store, and a score proportional to footfall.

14. The computer-implemented method of claim 9, wherein the product category score is determined according to the formula
Scoreᵢ=αp_{score}+(1−α)a_{score},
and is used to determine the relevant advertisement.

15. The computer-implemented method of claim 14, wherein the product score (p_{score}) is generated according to the formula
$$\frac{{f}_{score} - min ( {f}_{score} )}{max ( {f}_{score} ) - min ( {f}_{score} )}$$

16. The computer-implemented method of claim 14, wherein an advertisement score (a_{score}) is generated that is proportional to a number of advertisements relevant to a category of items.

17. A non-transitory machine-readable medium storing instructions executable by a computing device, wherein execution of the instructions causes the computing device to implement a method for targeted advertising, the method comprising:
capturing one or more images of a plurality of individuals in a location in a facility with an imaging device, wherein the one or more images are at least one of still and video images;
performing face detection on the one or more images;
producing, based on the faces detected, age estimation and gender identification for each detected face using a Convolutional Neural Network (CNN) based deep learning model;
determining a targeted audience based on pre-determined criteria using the age and gender identification of each detected face; and
selecting a relevant advertisement for the targeted audience for display on a display device, wherein the relevant advertisement is selected based at least in part on a footfall score (f_{score}) indicative of customer traffic in the facility.

18. The non-transitory machine-readable medium of claim 17, wherein the determining a targeted audience includes dividing the at least two detected faces into one of a group comprising teenage, adult, middle age adult, or older aged adult based on the age identification.

19. The non-transitory machine-readable medium of claim 17, wherein displaying a relevant advertisement by the targeted advertising module includes pre-categorization of products based on their pre-defined appropriateness in regards to gender and age.

20. The non-transitory machine-readable medium of claim 19, wherein the footfall score is generated based on mapping of a product category with a number of customers, a location within of the store, and a score proportional to footfall; wherein a product score (p_{score}) is generated according to the formula
$$\frac{{f}_{score} - min ( {f}_{score} )}{max ( {f}_{score} ) - min ( {f}_{score} )} ;$$
wherein an advertisement score (a_{score}) is proportional to a number of advertisements relevant to a category of items; and wherein the product category score (Scoreᵢ) is determined according to the formula
Scoreᵢ=αp_{score}+(1−α)a_{score}.
